(19) United States
(12) Patent Application Publication
(10) Pub. No.: US 2020/0031171 A1
(43) Pub. Date: Jan. 30, 2020

(54) PNEUMATIC TIRE

(71) Applicant: TOYO TIRE CORPORATION, Itami-shi (JP)

(72) Inventor: Tsuyoshi Fujioka, Itami-shi (JP)

(73) Assignee: TOYO TIRE CORPORATION, Itami-shi (JP)

(21) Appl. No.: 16/513,864

(22) Filed: Jul. 17, 2019

(30) Foreign Application Priority Data
Jul. 26, 2018 (JP) 2018-140261

(51) Int. Cl. B60C 11/12

(52) U.S. Cl. CPC B60C 11/1236; B60C 2011/0346; B60C 11/1259; B60C 11/1218

(57) ABSTRACT

Provided is a pneumatic tire in which a plurality of ribs which extend in a tire circumferential direction are formed in a tread portion by a plurality of main grooves which extend in the tire circumferential direction, wherein, in a center rib of the plurality of ribs, the center rib being divided at a center portion in a tire width direction, a plurality of closing slits which each extend in the tire width direction from one end portion communicating with the main groove, and terminate at another end portion in the center rib is formed, and wherein the plurality of closing slits are formed so as to be opposed to each other on both sides of the center rib in the tire width direction.

### CROSS-REFERENCE TO RELATED APPLICATIONS

This application claims priority of Japanese Patent Application No.: 2018-140261 filed on Jul. 26, 2018, the content of which is incorporated herein by reference.

### BACKGROUND F THE INVENTION

### Technical Field

The present invention relates to a pneumatic tire.

### Related art

In the disclosure of WO 2010/008370 A, in a pneumatic tire configured in a block pattern by main grooves which extend in the tire circumferential direction and lateral grooves which extend in the tire width direction, bridges which connect the blocks adjacent to each other in the tire circumferential direction are formed in order to suppress chunking (tread separation) of the blocks, and sipes are formed in the bridges in order to suppress occurrence of uneven wear which may be exacerbated thereby.

### SUMMARY

In order to suppress uneven wear of the tread portion, it is also conceivable to form the tread portion in a rib pattern to improve the rigidity of the land portion and suppress deformation of the land portion. However, in this case, since the traction factor is reduced as compared to the block pattern, the traction performance tends to be reduced.

An object of the present invention is to improve the traction performance of a pneumatic tire formed in a rib pattern while suppressing occurrence of uneven wear.

According to the present invention, there is provided a pneumatic tire in which a plurality of ribs which extend in a tire circumferential direction are formed in a tread portion by a plurality of main grooves which extend in the tire circumferential direction, wherein, in a center rib of the plurality of ribs, the center rib being divided at a center portion in a tire width direction, a plurality of closing slits which each extend in the tire width direction from one end portion communicating with the main groove, and terminate at another end portion in the center rib is formed, and wherein the plurality of closing slits are formed so as to be opposed to each other on both sides of the center rib in the tire width direction.

According to the present invention, in the pneumatic tire in which the tread portion is formed in a rib pattern, in the center rib, pairs of closing slits opposed to each other in the tire width direction are formed. By forming the tread portion in a rib pattern, the rigidity of the land portion (rib) can be easily secured, so that the wear resistance, the uneven wear resistance, and the low fuel consumption can be improved as compared to the block pattern.

Further, according to the closing slits, traction components which extend in the tire width direction are easily caused to act while suppressing the reduction in rigidity of the center rib. Moreover, since the closing slits are formed in a pair in the tire width direction in the center rib with high ground contact pressure among the plurality of ribs, the traction components by the pair of closing slits are easily caused to act on the road surface substantially at the same time at the time of grounding, which makes it easier to improve the traction performance.

Therefore, in the pneumatic tire formed in a rib pattern, occurrence of uneven wear is suppressed by suppressing the reduction in rib rigidity, and the traction performance can be improved by the pair of closing slits opposed to each other in the tire width direction.

It is preferable that, in a shoulder rib of the plurality of ribs, the shoulder rib being divided at an end portion on an outer side in the tire width direction, closing slits which each extend in the tire width direction from one end portion communicating with the main groove, and terminate in the shoulder rib at another end portion, and closing slits which each extend in the tire width direction from one end portion communicating with a ground contact end on the outer side in the tire width direction, and terminate in the shoulder rib at another end portion are alternately formed in the tire circumferential direction.

Further, it is preferable that, in each of intermediate ribs of the plurality of ribs, the intermediate rib being divided between the center rib and the shoulder rib in the tire width direction, closing slits which each extend in the tire width direction from one end portion communicating with the main groove located on the center rib side, and terminate in the intermediate rib at another end portion, and closing slits which each extend in the tire width direction from one end portion communicating with the main groove located on the shoulder rib side, and terminate in the intermediate rib at another end portion are alternately formed in the tire circumferential direction.

Since the shoulder ribs and the intermediate ribs have lower ground contact pressure than the center rib, uneven wear tends to occur as compared to the center rib due to the slip of the contact surface at the time of grounding. Therefore, according to this configuration, in the shoulder ribs arid the intermediate ribs in which uneven wear easily occurs as compared to the center rib, the closing slits are not formed so as to be opposed to each other in the tire width direction, but are alternately formed in the tire circumferential direction on the outer side and the inner side in the tire width direction. As a result, the traction performance is improved by the closing slits, and the rigidity of the shoulder ribs and the intermediate ribs is easily made uniform in the tire circumferential direction, so that the occurrence of uneven wear is suppressed.

Further, it is preferable that the plurality of main grooves extend in a zigzag manner in the tire circumferential direction, and that the closing slits communicating with the main grooves are formed at concave corner portions of the plurality of ribs, the concave corner portions being divided into a concave shape in the tire width direction by the main grooves.

According to this configuration, the closing slits are formed at the concave corner portions of the plurality of ribs, the concave corner portions being divided into a concave shape. That is, since the ribs are formed to have an angle of 180 degrees or more at the concave corner portions in plan view, the convex corner portions formed by being divided by the closing slits through formation of the closing slits at the concave corner portions are less likely to have acute angles. Therefore, the reduction in rigidity of the ribs due to the closing slits can be suppressed.

In addition, it is preferable that, in the center rib, closing slit pairs are each formed by a pair of the closing slits opposed to each other in the tire width direction, and that connecting slits which connect, in the tire width direction, the plurality of closing slit pairs aligned in the tire circumferential direction so as to be alternate in the tire circumferential direction and are shallower than closing slits are formed.

According to this configuration, since the edge component of the center rib which extends in the tire width direction can be increased by the connecting slits, the traction performance can be further improved. Moreover, since the connecting slits are shallower than the closing slit and are formed alternately in the tire circumferential direction at the plurality of closing slit pairs aligned in the tire circumferential direction, the reduction in rigidity of the center rib due to the connecting slits is suppressed while securing the traction performance at the initial stage of wear.

Further, it is preferable that, in each of the plurality of ribs, a plurality of sipes which extend in the tire width direction are formed, and that, in each rib, at least the sipe longest in the tire width direction among the plurality of sipes is a 3D sipe whose shape changes along a tire radial direction.

According to this configuration, the traction performance is improved by the sipes respectively formed in the plurality of ribs. In this case, the amount of deformation is likely to increase in the portions of the ribs which correspond to the sipes longest in the tire width direction. By forming the sipes into 3D sipes, excessive deformation is suppressed, thereby suppressing the occurrence of uneven wear.

Further, the mold release property is easier to secure at the tune of tire vulcanization molding in the case where at least the sipes longest in the tire width direction among the plurality of sipes are formed into 3D sipes as compared to the case where all the sipes are formed into 3D sipes.

In addition, it is preferable that, in the 3D sipe, a center portion in the tire width direction is deeper in the tire radial direction than both side portions in the tire width direction.

According to this configuration, excessive deformation of the portions where the 3D sipes are formed is suppressed by making the both side portions of the 3D sipes shallow.

In addition, it is preferable that, in the center rib and the intermediate rib, a larger number of sipes are formed than in the shoulder rib.

According to this configuration, in the center rib with high ground contact pressure, traction is easily effectively exerted by the closing slits formed in a pair in the tire width direction and the center sipes relatively large in number. On the other hand, in the shoulder rib with low ground contact pressure, the closing slits are not formed in a pair in the tire width direction, and the number of the sipes to be formed is suppressed. With this, the reduction in rigidity of the shoulder rib is suppressed, thereby suppressing the occurrence of uneven wear in the shoulder rib.

Further, in the intermediate rib, the closing slits are not formed in a pair in the tire width direction, and the sipes are formed relatively larger in number. With this, the traction performance is easily exerted while suppressing the reduction in rigidity of the intermediate rib.

Therefore, the traction performance is effectively improved in the center rib where the ground contact pressure tends to be relatively high, the occurrence of the uneven wear is suppressed in the shoulder rib where the ground contact pressure tends to be relatively low, and the improvement of the traction performance and the suppression of the occurrence of the uneven wear can be attained in a well-balanced manner in the intermediate rib where the ground contact pressure tends to be the middle of these.

In addition, it is preferable that a formation pitch in the tire circumferential direction of the plurality of sipes formed in the center rib is 5% or more and 40% or less of a length of the center rib in the tire width direction.

According to this configuration, in the center rib with high ground contact pressure, the excessive deformation of the center rib can be suppressed while securing the traction performance by the sipes. When the formation pitch of the sipes is less than 5% of the width of the center rib, it tends to be a cause of chipping or cracking of the center rib. When the formation pitch of the sipes in the center rib is larger than 40% of the width of the center rib, the number of the sipes is reduced and the improvement in traction performance tends to be insufficient.

In addition, it is preferable that a formation pitch in the tire circumferential direction of the plurality of sipes formed in the shoulder rib is 30% or more and 60% or less of a length of the shoulder rib in the tire width direction.

According to this configuration, in the shoulder rib with low ground contact pressure, the number of the sipes to be formed is suppressed, so that excessive deformation of the shoulder rib is suppressed. When the formation pitch of the sipes in the shoulder rib is less than 30% of the width of the shoulder rib, the rigidity of the shoulder rib tends to be excessively reduced, which tends to be a cause of uneven wear. When the formation pitch of the sipes in the shoulder rib is larger than 60% of the width of the shoulder rib, the number of the sipes is reduced and the improvement in traction performance tends to be insufficient.

According to the present invention, the traction performance of the pneumatic tire formed in a rib pattern can be improved while suppressing the occurrence of uneven wear.

### BRIEF DESCRIPTION OF THE DRAWINGS

The foregoing and the other features of the present invention will become apparent from the following description and drawings of an illustrative embodiment of the invention in which:

FIG. 1 is a meridional half sectional view of a pneumatic tire according to an embodiment of the present invention;

FIG. 2 is a partially developed view of a tread portion in FIG. 1;

FIG. 3 is a perspective view of a center rib as viewed in the direction of the arrow A in FIG. 2;

FIG. 4 is a perspective view of an intermediate rib as viewed in the direction of the arrow B in FIG. 2;

FIG. 5 is a perspective view of a shoulder rib as viewed in the direction of the arrow C in FIG. 2; and

FIG. 6 is a sectional view of a 3D sipe taken along the line VI-VI in FIG. 2.

### DETAILED DESCRIPTION OF EMBODIMENTS

Hereinafter, an embodiment of the present invention will be described with reference to the attached drawings. It should be noted that the following description is merely exemplary in nature and is not intended to limit the present invention, its application, or its usage. In addition, the drawings are schematic, and ratios of dimensions and the like are different from actual ones.

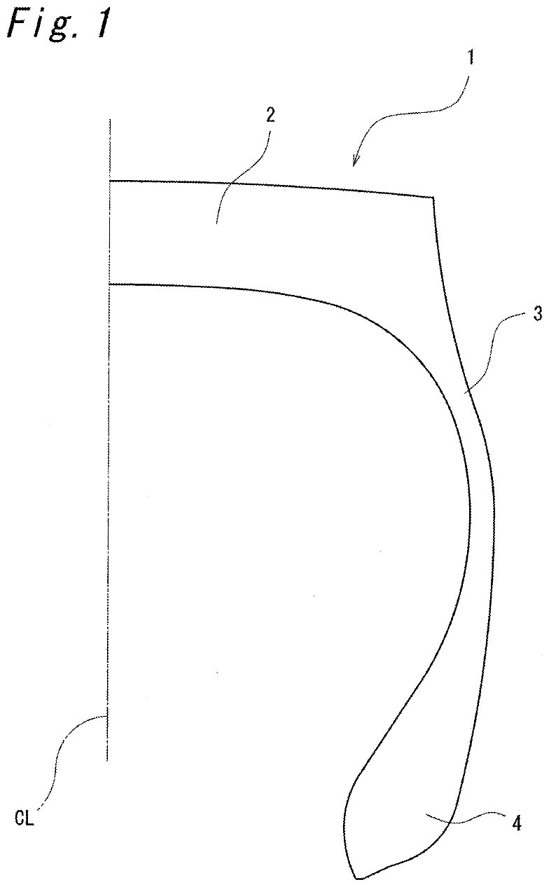

FIG. 1 is a sectional view in the direction of the meridian of a pneumatic tire 1 according to an embodiment of the present invention, in which one side (right side in FIG. 1) of a tire equator line CL is illustrated. As illustrated in FIG. 1, the pneumatic tire 1 includes a tread portion 2 in contact with a road surface, a side portion 3 which extends inward in the tire radial direction continuously with an outer end portion of the tread portion 2 in the tire width direction, and a bead portion 4 located at inner end portion of the side portion 3 in the tire radial direction and assembled to a rim of a wheel (not shown).

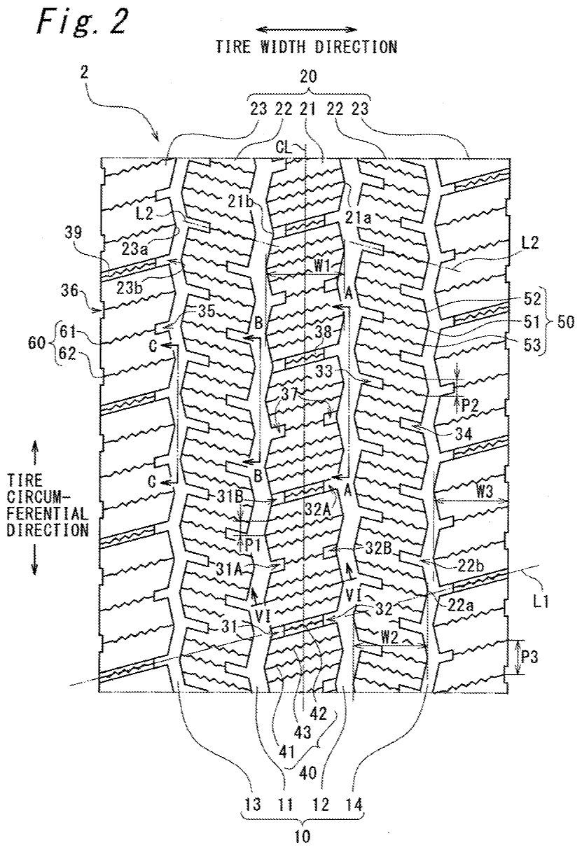

FIG. 2 is a partially developed view of the tread portion 2 illustrated in FIG. 1. The tread portion 2 is formed with a plurality of main grooves 10 which extend annularly in a zigzag manner in the tire circumferential direction. In the present embodiment, the plurality of main grooves 10 includes first to fourth main grooves 11 to 14. The first and second main grooves 11 and 12 are formed in a pair at the center of the tread portion 2 in the tire width direction on both right and left sides across the tire equator line CL. The third main groove 13 is formed on the outer side in the tire width direction with respect to the first main groove 11. The fourth main groove 14 is formed on the outer side in the tire width direction with respect to the second main groove 12.

Further, in the tread portion 2, a plurality of ribs 20 are divided by the plurality of main grooves 10. Specifically, a center rib 21 is for med between the first and second main grooves 11 and 12 in the tire width direction by being divided thereby. Further, in the tread portion 2, intermediate ribs 22 are respectively formed between the first main groove 11 and the third main groove 13 in the tire width direction and between the second main groove 12 and the fourth main groove 14 in the tire width direction.

Furthermore, in the tread portion 2, shoulder ribs 23 are formed respectively on the outer side of the third main groove 13 in the tire width direction between the third main groove 13 and the ground contact end portion in the tire width direction and on the outer side of the fourth main groove 14 in the tire width direction between the fourth main groove 14 and the ground contact end portion in the tire width direction. In the pneumatic tire 1, the end portions of the tread portion 9 in the tire width direction constitute the ground contact end portions, and the shoulder ribs 23 are portions in the tread portion 2 which are divided to the outer side in the tire width direction by the third and fourth main grooves 13 and 14.

That is, the tread portion 2 is divided by the first to fourth main grooves 11 to 14 into the center rib 21, the pair of right and left intermediate ribs 22, and the pair of right and left shoulder ribs 23 which extend annularly in the tire circumferential direction.

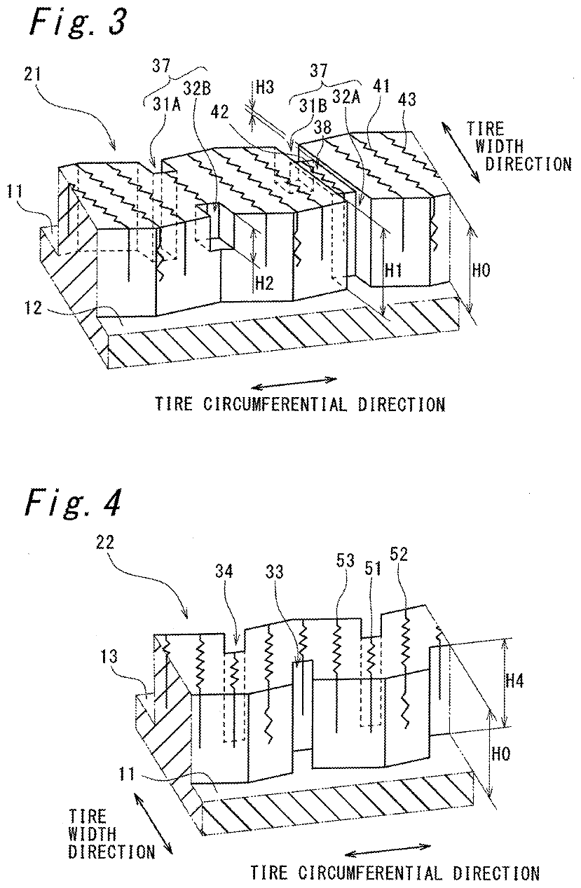

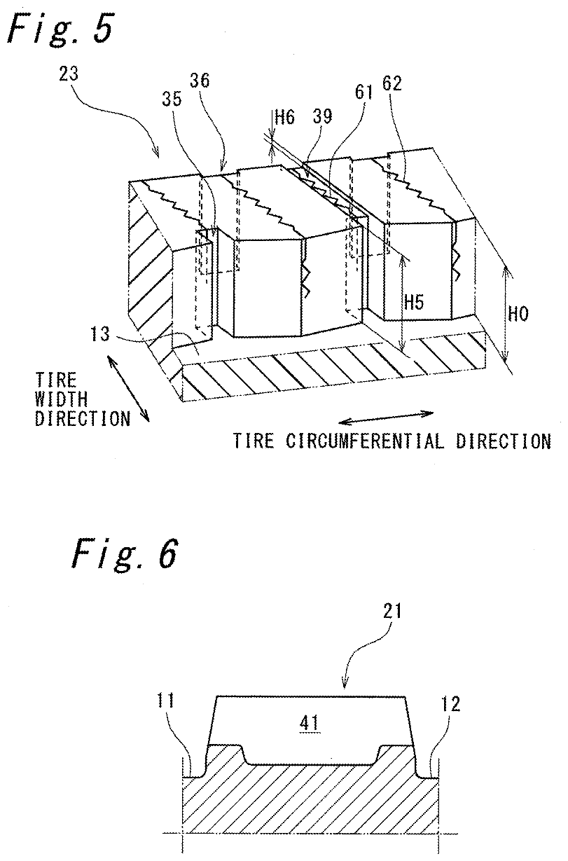

FIG. 3 is a perspective view of the center rib 21 as viewed in the direction of arrow A in FIG. 2, FIG. 4 is a perspective view of the intermediate rib 22 as viewed in the direction of arrow B in FIG. 2, and FIG. 5 is a perspective view of the shoulder rib 23 in the direction of arrow C in FIG. 2. As illustrated in FIGS. 3 to 5, in the present embodiment, the groove depth of the main groove 10 is set to H0. The groove depths of the first to fourth main grooves 11 to 14 may be set to be different from each other.

(Center Rib)

As illustrated in FIG. 2, since the center rib 21 is divided by the first and second main grooves 11 and 12 which extend in a zigzag manner in the tire circumferential direction, in plan view, the side wall portions on the outer side in the tire width direction each include a plurality of convex corner portions 21a formed in a convex shape and a plurality of concave corner portions 21b formed in a concave shape, which are formed in a zigzag manner so as to be alternately located in the tire circumferential direction.

At the concave corner portion 21b of the center rib 21 formed by the first main groove 11, a first closing slit 31 which extends in the tire width direction from one end portion communicating with the first main groove 11, and terminates in the center rib 21 at the other end portion is formed. Similarly, at the concave corner portion 21b of the center rib 21 formed by the second main groove 12, a second closing slit 32 which extends in the tire width direction from one end portion communicating with the second main groove 12, and terminates in the center rib 21 at the other end portion is formed.

The first and second closing slits 31 and 32 are formed in a pair across the tire equator line CL in the tire width direction, and the pair of closing slits 31 and 32 constitutes a closing slit pair 37. That is, in the center rib 21, a plurality of dosing slit pairs 37 are formed at intervals in the tire circumferential direction.

In the closing slit pair 37, the first and second closing slits 31 and 32 extend on the same straight line L1 that is inclined to one side in the tire width direction towards the tire circumferential direction (upward to the right in FIG. 1), and the other end portions are located so as to be opposed to each other in the tire width direction across the tire equator line CL.

Further, in the center rib 21, connecting slits 38 which connect the plurality of closing slit pairs 37 along the extending direction thereof (that is, the straight line L1) are formed alternately in the tire circumferential direction.

Referring also to FIG. 3, the plurality of first closing slits 31 include a first dosing deep slits 31A having a relatively deep groove depth and first closing shallow slits 31B having a relatively shallow groove depth, which are formed to be alternately located in the tire circumferential direction. A groove depth H1 of the first closing deep slit 31A is set to be the same as a groove depth H0 of the main groove 10. A groove depth H2 of the first closing shallow slit 31B is set to about 50% of the groove depth H0 of the main groove 10.

Similarly, the plurality of second closing slits 32 have second closing deep slits 32A and second closing shallow slits 32B. The second closing deep slits 32A and the second closing shallow slits 32B are alternately located in the tire circumferential direction, and the depths of the respective, grooves are set to H1 and H2.

Further, in the closing slit pair 37, the groove depth of one of the first and second closing slits 31 and 32 is set to H1, and the groove depth of the other of the first and second closing slits 31 and 32 is set to H2. Therefore, in the center rib 21, the first and second closing deep slits 31A and 32A are configured to be alternately located on the first main groove 11 side and the second main groove 12 side in the tire circumferential direction, and the first and second closing shallow slits 31B and 32B are alternately located on the first main groove 11 side and the side of the second main groove 12 side in the tire circumferential direction.

A depth H3 of the connecting slit 38 is set to 3% or more and 90% or less of the groove depth H0 of the main groove 10.

Further, in the center rib 21, a plurality of center sipes 40 penetrating the center rib 21 in the tire width direction are formed. The plurality of center sipes 40 are configured as wavy sipes which extend in a zigzag manner along the straight line L1, and include first to third center sipes 41 to 43.

As illustrated in FIG. 2, the first center sipe 41 is formed to connect the convex corner portions 21a divided by the first and second main grooves 11 and 12 in the tire width direction. The second center sipe 49 is formed to connect the closing slit pair 37 in the tire width direction. The third center sipe 43 is formed at a substantially inter mediate position between the first center sipe 41 and the second center sipe 42 in the tire circumferential direction.

Of the center sipes 40, the first center sipe 41 is the longest in the tire width direction. As illustrated in FIG. 3, the first center sipe 41 is configured as a 31 sipe whose shape changes along the tire radial direction.

As illustrated in FIG. 2, a formation pitch P1 of the center sipes 40 in the tire circumferential direction is set to 5% or more and 40% or less of a length W1 of the center rib 21 in the tire width direction. Here, the length W1 of the center rib 21 in the tire width direction means the maximum length in the tire width direction, and means the length of the portion between the convex corner portion 21a formed by the first main groove 11 and the convex corner portion 21a formed by the second main groove 12 in the tire width direction.

(Intermediate Rib)

Since the intermediate rib 22 is divided by the first main groove 11 and the third main groove 13 which extend in a zigzag manner in the tire circumferential direction, or by the second main groove 12 and the fourth main groove 14 which extend in a zigzag manner in the tire circumferential direction, the side wall portions on both sides in the tire width direction each include a plurality of convex corner portions 22a and a plurality of concave coiner portions 22b, which are formed in a zigzag manner so as to be alternately located in the tire circumferential direction.

At the concave corner portion 22b of the intermediate rib 22 formed by the first main groove 11 (or the second main groove 12), a third closing slit 33 which extends in the tire width direction from one end portion communicating with the first main groove 11 (or the second main groove 12), and terminates in the intermediate rib 22 at the other end portion is formed. Similarly, at the concave corner portion 22b formed by the third main groove 13 (or the fourth main groove 14), a fourth closing slit 34 which extends in the tire width direction from one end portion communicating with the third main groove 13 (or the fourth main groove 14), and terminates in the center rib 21 at the other end portion is formed.

The third and fourth closing slits 33 and 34 are alternately formed in the tire circumferential direction, and each extend along a straight line L2 that is inclined to the side opposite to the first and second closing slits 31 and 32 towards the tire circumferential direction (upward to the left in FIG. 1). As illustrated in FIG. 4, groove depths H4 of the third and fourth closing slits 33 and 34 are set to be the same as the groove depth H0 of the main groove 10.

As illustrated in FIG. 2, in the intermediate rib 22, a plurality of intermediate sipes 50 penetrating the intermediate rib 22 in the tire width direction are formed. The plurality of intermediate sipes 50 are configured as wavy sipes which extends in a zigzag manner along the straight line L2, and include first to third intermediate sipes 51 to 53.

The first intermediate sipe 51 is formed to connect the third closing slit 33 and the third main groove 13 (or the fourth main groove 14) in the tire width direction, or the fourth closing slit 34 and the first main groove 11 (or the second main groove 12) in the tire width direction.

The second and third intermediate sipes 52 and 53 are formed between the third and fourth closing slits 33 and 34 adjacent to each other in the tire circumferential direction. Of the intermediate sipes 50, the second intermediate sipe 52, is the longest in the tire width direction. As illustrated in FIG. 4, the second intermediate sipe 52 is configured as a 3D sipe whose shape changes along the tire radial direction.

As illustrated in FIG. 2, a formation pitch P2 of the intermediate sipes 50 in the tire circumferential direction is set to 5% or more and 40% or less of a length W2 of the intermediate rib 22 in the tire width direction. Here, the length W2 of the intermediate rib 22 in the tire width direction means the maximum length in the tire width direction, and means the length of the portion between the convex corner portion 22a formed by the first main groove 11 (or the second main groove 12) and the convex corner portion 22a formed by the third main groove 13 (or the fourth main groove 14) in the tire width direction.

Further, the number of the intermediate sipes 50 is set to be substantially the same as the number of the center sipes 40.

(Shoulder Rib)

Since the side wall portion of the shoulder rib 23 which is located on the inner side in the tire width direction is divided by the third main groove 13 or the fourth main groove 14 which extends in a zigzag manner in the tire circumferential direction, the side wall portion includes a plurality of convex corner portions 23a and a plurality of concave corner portions 23b, which are formed in a zigzag manner so as to be alternately located in the tire circumferential direction. On the other hand, the side wall portion of the shoulder rib 23 which is located on the outer side in the tire width direction is constituted by the side wall portion of the tread portion 2 and extends substantially linearly along the tire circumferential direction.

At the concave corner portion 23b of the shoulder rib 23 formed by the third main groove 13 or the fourth main groove 14, a fifth closing slit 35 which extends in the tire width direction from one end portion communicating with the third main groove 13 or the fourth main groove 14, and terminates in the shoulder rib 23 at the other end portion is farmed.

The fifth closing slit 35 is formed at a position where the first and second closing slits 31 and 32 formed in the center rib 21 are extended in the extending direction thereof, and extends parallel to the straight line L1. In other words, the fifth closing slit 35 and the first and second closing slits 31 and 32 are configured to be located on the same straight line L1.

Further, shallow grooves 39 are formed alternately in the tire circumferential direction at the plurality of fifth closing slits 35 aligned in the tire circumferential direction so as to extend from the other end portion of the fifth slit 35 to the outer side in the tire width direction and communicate with the ground contact end (that is, the outer end portion of the tread portion 2 in the tire width direction).

Further, at outer end portion of the shoulder rib 23 in the tire width direction, a sixth closing slit 36 is further formed at an approximately intermediate position of the end portions extended in a direction parallel to the straight line L1 from the fifth closing slits 35 adjacent to each other in the tire circumferential direction. That is, in the shoulder rib 23, the fifth and sixth closing slits 35 and 36 are alternately formed in the tire circumferential direction.

As illustrated in FIG. 5, groove depths H5 of the fifth and sixth closing slits 35 and 36 are set to the groove depth H0 which is the same as the main groove 10. A groove depth H6 of the shallow groove 39 is set to 3% or more and 20% or less of the groove depth H5 of the fifth closing slit 35.

As illustrated in FIG. 2, in the shoulder rib 23, a plurality of shoulder sipes 60 penetrating the shoulder rib 23 in the tire width direction are formed. The plurality of shoulder sipes 60 are configured as wavy sipes which extend in a zigzag manner along the straight line L1, and include first and second shoulder sipes 61 and 62.

The first shoulder sipe 61 is formed to connect the fifth closing slit 35 and the ground contact end in the tire width direction. The second shoulder sipe 62 is formed to connect the convex corner portion 23a divided by the third or fourth main groove 13, 14 and the sixth closing slit 36 in the tire width direction.

Of the shoulder sipes 60, the second shoulder sipe 62 is the longest in the tire width direction. As illustrated in FIG. 5, the second shoulder sipe 62 is configured as a 3D sipe whose shape changes along the tire radial direction.

As illustrated in FIG. 2, a formation pitch P3 of the shoulder sipes 60 in the tire circumferential direction is set to 30% or more and 60% or less of a length W3 of the shoulder rib 23 in the tire width direction. Here, the length W3 of the shoulder rib 23 in the tire width direction means the maximum length in the tire width direction, and means the length of the portion between the convex corner portion 3a formed by the third main groove 13 (or the fourth main groove 14) and the ground contact end in the tire width direction.

Further, the number of the shoulder sipes 60 is less than the number of the center sipes 40 and the number of the intermediate sipes 50, and specifically, is 40% or more and 60% or less of the number of the center sipes 40 and the number of the intermediate sipes 50.

The first to fifth closing slits 31 to 35 are formed at the concave corner portions 21b, 22b, and 23b of the first to fourth main grooves 11 to 14 which extend in a zigzag manner in the tire circumferential direction. Specifically, in the plan view illustrated in FIG. 2, the first to fifth closing slits 31 to 35 are formed so that angles of the convex corner portions formed with respect to the side wall portions of the center rib 21, the intermediate rib 22, and the shoulder rib 23 divided in the tire width direction are about 90 degrees or more.

FIG. 6 is a sectional view taken along line VT-VI in FIG. 2 along the first center sipe 41. As illustrated in FIG. 6, in the tire width direction, the first center sipe 41 configured as a 3D sipe is formed to be deeper in the tire radial direction at the center portion in the tire width direction than at both side portions in the tire width direction. Although illustration is omitted, the second intermediate ripe 52 and the second shoulder sips 62 configured as 3D Sipes are also formed to be deeper in the tire radial direction, at the center portion in the tire width direction than at both side portions in the tire width direction.

According to the pneumatic tire 1 described above, the following effects are obtained.

(1) In the pneumatic tire 1 in which the tread portion 2 is formed in a rib pattern, in the center rib 21, pairs of first and second closing slits 31 and 32 opposed to each other in the tire width direction are formed. By forming the tread portion 2 in a rib pattern, the rigidity of the land portion (rib) can be easily secured, so that the wear resistance, the uneven wear resistance, and the low fuel consumption can be improved compared to the block pattern.

Further, according to the first and second closing slits 31 and 32, traction components which extend in the tire width direction are easily caused to act while suppressing the reduction in rigidity of the center rib 21. Moreover, since the first and second closing slits 31 and 32 are formed in a pair in the tire width direction in the center rib 21 with high ground contact pressure among the plurality of ribs 20, the traction components by the pair of first and second closing slits 31 and 32 are easily caused to act on the road surface substantially at the same time at the time of grounding, which makes it easier to improve the traction performance.

Therefore, in the pneumatic tire 1 formed in a rib pattern, occurrence of uneven wear is suppressed by suppressing the reduction in rib rigidity, and the traction performance can be improved by the pair of opposing first and second closing slits 31 and 32.

(2) Since the shoulder ribs 23 and the intermediate ribs 22 have lower ground contact pressure than the center rib 21, uneven wear tends to occur as compared to the center rib 21 due to the slip of the contact surface at the time of grounding. In the shoulder ribs 23 and the intermediate ribs 22 in which uneven wear easily occurs as compared to the center rib 21, the third to sixth closing slits 33 to 36 are not formed so as to be opposed to each other in the tire width direction, but are alternately formed in the tire circumferential direction on the outer side and the inner side in the tire width direction. As a result, the traction performance is improved by the third to sixth closing slits 33 to 36, and the rigidity of the shoulder ribs 23 and the intermediate ribs 22 is easily made uniform in the tire circumferential direction, so that the occurrence of uneven wear is suppressed.

(3) The first to fifth closing slits 31 to 35 (hereinafter collectively referred to as “closing slits 30”) are formed at the concave corner portions 21b, 22b, and 23b divided into a concave shape (hereinafter collectively referred to as “concave corner portions 20b”) of the plurality of ribs 20. That is, since the ribs 20 are formed to have an angle of 180 degrees or more at the concave corner portions 20b in plan view, the convex corner portions formed by being divided by the closing slits 30 through formation of the closing slits 30 at the concave corner portions 20b are less likely to have acute angles. Therefore, the reduction in rigidity of the ribs due to the closing slits 30 can be suppressed.

In particular, in the present embodiment, in the plan view illustrated in FIG. 2 each closing slit 30 is formed so that the angle of the corner portion formed with respect to the side wall portion of each rib 20 divided on both sides in the tire width direction is about 90 degrees or more. For this reason, since the reduction in rigidity of the corner portion formed by being divided by the closing slit 30 is suppressed, the reduction in rib rigidity is further suppressed.

(4) Since the edge component of the center rib 21 which extends in the tire width direction can be increased by the connecting slits 38, the traction performance can be further improved. Moreover, since the connecting slits 38 are shallower than the closing slit 30 and are formed alternately in the tire circumferential direction at the plurality of closing slit pairs 37 aligned in the tire circumferential direction, the reduction in rigidity of the center rib 21 due to the connecting slits 38 is suppressed while securing the traction performance at the initial stage of wear.

Similarly, since the edge component of the shoulder rib 23 which extends in the tire width direction can be increased by the shallow grooves 39, the traction performance can be further improved. In addition, since the shallow grooves 39 are shallower than the closing slit 30 and are formed alternately in the tire circumferential direction at the plurality of fifth closing slits 35 aligned in the tire circumferential direction, the reduction in rigidity of the shoulder rib 23 due to the shallow grooves 39 is suppressed while securing the traction performance at the initial stage of wear.

(5) The traction performance is improved by the sipes 40, 50, and 60 respectively formed in the plurality of ribs 20. In this case, the amount of deformation is likely to increase in the portions of the ribs 20 which correspond to the sipes longest in the tire width direction, that is, the first center sipe 41, the second intermediate sipe 52, and the second shoulder sipe 62. By for cling the sipes 41, 52, and 62 into 3D sipes, excessive deformation is suppressed, thereby suppressing the occurrence of uneven wear.

Further, the mold release property is easier to secure at the time of tire vulcanization molding in the case where at least the sipes 41, 52, 62 longest in the tire width direction in each rib 20 among the plurality of sipes 40, 50, and 60 are formed into 3D sipes as compared to the case where all the sipes 40, 50, and 60 are formed into 3D sipes.

(6) Excessive deformation of the portions in which the 3D sipes are formed is suppressed by making the sipes 41, 52, and 62 configured as 3D sipes shallower on both side portions than the center portion in the tire width direction.

(7) In the center rib 21 with high ground contact pressure, traction is easily effectively exerted by the first and second closing slits 31 and 32 formed in a pair in the tire width direction and the center sipes 40 relatively large in number. On the other hand, in the shoulder rib 23 with low ground contact pressure, the fifth and sixth closing slits 35 and 36 are not foamed in a pair in the tire width direction, and the number of the shoulder sipes 60 to be formed is suppressed as compared to that in the center rib 21. With this, the reduction in rigidity of the shoulder rib 23 is suppressed, thereby suppressing the occurrence of uneven wear in the shoulder rib 23.

Further, in the intermediate rib 22, the third and fourth closing slits 33 and 34 are not formed in a pair in the tire width direction, and the intermediate sipes 50 are formed larger in number than in the shoulder rib 23. With this, the traction performance is easily exerted while suppressing the reduction in rigidity of the intermediate rib 22.

Therefore, the traction performance is effectively improved in the center rib 21 where the ground contact pressure tends to be relatively high, the occurrence of the uneven wear is suppressed in the shoulder rib 23 where the ground contact pressure tends to be relatively low, and the improvement of the traction performance and the suppression of the occurrence of the uneven wear can be attained in a well-balanced manner in the intermediate rib 22 where the ground contact pressure tends to be the middle of these.

(8) The formation pitch P1 of the center sipes 40 is set to 5% or more and 40% or less of the length W1 of the center rib 21 in the tire width direction. Therefore, in the center rib 21 with high ground contact pressure, excessive deformation of the center rib can be suppressed while securing the traction performance by the center sipes 40. When the formation pitch P1 of the center sipes 40 is less than 5% of the width W1 of the center rib 21, it tends to be a cause of chipping or cracking of the center rib 21. When the formation pitch P1 of the center sipes 40 in the center rib 21 is larger than 40% of the width W1 of the center rib 21, the number of the center sipes 40 is reduced and the improvement in traction performance tends to be insufficient.

(9) The formation pitch P3 of the shoulder sipes 60 is set to 30% or more and 60% or less of the length W3 of the shoulder rib 23 in the tire width direction. As a result, in the shoulder rib 23 with low ground contact pressure, the number of the shoulder sipes 60 to be formed is suppressed, so that excessive deformation of the shoulder rib 23 is suppressed. When the formation pitch P3 of the shoulder sipes 60 in the shoulder rib 23 is less than 30% of the width W3 of the shoulder rib 23, the rigidity of the shoulder rib 23 tends to be excessively reduced, which tends to be a cause of uneven wear. When the formation pitch P3 of the shoulder sipes 60 in the shoulder rib 23 is larger than 60% of the width W3 of the shoulder rib 23, the number of the shoulder sipes 60 is reduced and the improvement in traction performance tends to be insufficient.

(10) The closing slit pair 37 formed in the center rib 21, the connecting slit 38 connecting the closing slit pair 37 in the tire width direction, the fifth closing slit 35 formed in the shoulder rib 23, and the shallow groove 39 which is connected to the fifth closing slit 35 and extends to the outer side in the tire width direction are located on the same line L1. With this, since the edge components of the connecting slit 38 and the shallow groove 39 uniformly act on the road surface along with the tire rolling, the traction performance accompanying the tire rolling can be effectively exhibited without being impaired. That is, at the time of tire rolling, the edge component of either the connecting slit 38 or the shallow groove 39 acts on the road surface, so that the traction performance is easily effectively exerted.

In the embodiment described above, although the four main grooves 10 are provided, but the present invention is not limited thereto, and it is only necessary that two car more main grooves 10 are provided. In addition, when two main grooves 10 are provided, a center rib between the two main grooves 10 is divided, and further, shoulder ribs are divided on both sides of the two main grooves 10 in the tire width direction.

Moreover, in the embodiment described above, although the case where each main groove 10 extends in a zigzag manner in the tire circumferential direction is described as an example, the present invention is not limited thereto. Therefore, each main groove 10 may extend linearly in the tire circumferential direction.

In addition, the present invention is not limited to the structure described in the embodiment described above, and various modifications may be made thereto.

What is claimed is:

1. A pneumatic tire in which a plurality of ribs which extend in a tire circumferential direction are formed in a tread portion by a plurality of main grooves which extend in the tire circumferential direction,
wherein, in a center rib of the plurality of ribs, the center rib being divided at a center portion in a tire width direction, a plurality of closing slits which each extend in the tire width direction from one end portion communicating with the main groove, and terminate at another end portion in the center rib is formed, and
wherein the plurality of closing slits are formed so as to be opposed to each other on both sides of the center rib in the tire width direction.

2. The pneumatic tire according to claim 1,
wherein, in each of shoulder ribs of the plurality of ribs, the shoulder rib being divided at an end portion on an outer side in the tire width direction, closing slits which each extend in the tire width direction from one end portion communicating with the main groove, and terminate in the shoulder rib at another end portion, and closing slits which each extend in the tire width direction from one end portion communicating with a ground contact end on the outer side in the tire width direction, and terminate in the shoulder rib at another end portion are alternately formed in the tire circumferential direction.

3. The pneumatic tire according to claim 2,
wherein, in each of intermediate rips of the plurality of ribs, the intermediate rib being divided between the center rib and the shoulder rib in the tire width direction, closing slits which each extend in the tire width direction from one end portion communicating with the main groove located on the center rib side, and terminate in the intermediate rib at another end portion, and closing slits which each extend in the tire width direction from one end portion communicating with the main groove located on the shoulder rib side, and terminate in the intermediate rib at another end portion are alternately formed in the tire circumferential direction.

4. The pneumatic tire according to claim 1,
wherein the plurality of main grooves extend in a zigzag manner in the tire circumferential direction, and
wherein the closing slits communicating with the main grooves are formed at concave corner portions of the plurality of ribs, the concave corner portions being are divided into a concave shape in the tire width direction by the main grooves.

5. The pneumatic tire according to claim 1,
wherein, in the center rib, closing slit pairs are each formed by a pair of the closing slits opposed to each other in the tire width direction, and
wherein connecting slits which connect, in the tire width direction, the plurality of closing slit pairs aligned in the tire circumferential direction so as to be alternate in the tire circumferential direction and are shallower than closing slits are formed.

6. The pneumatic tire according to claim 3,
wherein, in each of the plurality of ribs, a plurality of sipes which extend in the tire width direction are formed, and
wherein, in each rib, at least the sipe longest in the tire width direction among the plurality of sipes is a 3D sipe whose shape changes along a tire radial direction.

7. The pneumatic tire according to claim 6, wherein, in the 3D sipe, a center portion in the tire width direction is deeper in the tire radial direction than both side portions in the tire width direction.

8. The pneumatic tire according to claim 6, wherein, in the center rib and the intermediate rib, a larger number of sipes are formed than in the shoulder rib.

9. The pneumatic tire according to claim 6, wherein a formation pitch in the tire circumferential direction of the plurality of sipes formed in the center rib is 5% or more and 40% or less of a length of the center rib in the tire width direction.

10. The pneumatic tire according to claim 6, wherein a formation pitch in the tire circumferential direction of the plurality of sipes formed in the shoulder rib is 30% or more and 60% or less of a length of the shoulder rib in the tire width direction.
